(19) United States
(12) Patent Application Publication
(10) Pub. No.: US 2025/0197646 A1
(43) Pub. Date: Jun. 19, 2025

(54) POLYVINYL ALCOHOL ACRYLATE DISPERSION COPOLYMER

(71) Applicant: Buckman Laboratories International, Inc., Memphis, TN (US)

(72) Inventor: Ahmed MOUSTAFA, Germantown, TN (US)

(73) Assignee: Buckman Laboratories International, Inc., Memphis, TN (US)

(21) Appl. No.: 18/970,979

(22) Filed: Dec. 6, 2024

Related U.S. Application Data
(60) Provisional application No. 63/610,441, filed on Dec. 15, 2023.

(51) Int. Cl. C09D 4/06; C09D 5/02; C09D 7/45; C09D 7/65; C09D 7/80; C09D 133/10; C09D 133/14; D21H 19/12

(52) U.S. Cl. CPC C09D 4/06; C09D 5/022; C09D 5/027; C09D 7/45; C09D 7/65; C09D 7/80; C09D 133/10; C09D 133/14; D21H 19/12

(57) ABSTRACT

A polyvinyl alcohol acrylate dispersion copolymer is provided that is a reaction product of a reactive aqueous solution for emulsion polymerization. The reactive aqueous solution includes: an acryl monomer; a partially hydrolyzed polyvinyl alcohol; one or more water-soluble monomers; and water. The acryl monomer can be an ester of an unsaturated carboxylic acid monomer, an ester of acrylic acid, an ester of methacrylic acid, an acrylate monomer, a methacrylate monomer, or a combination thereof. The one or more water-soluble monomers can be or include a carboxylic acid monomer and/or an amide monomer. Also provided are products utilizing the dispersion copolymer and methods of use and methods of making the dispersion copolymer.

### BACKGROUND OF THE INVENTION

This application claims the benefit under 35 U.S.C. § 119 (e) of prior U.S. Provisional Patent Application No. 63/610,441 filed Dec. 15, 2023, which is incorporated in its entirety by reference herein.

The present invention relates to a dispersion copolymer, and the use of a dispersion copolymer for paper or paperboard coatings, and products thereof.

Acrylate coatings on paper are widely used in various industries to enhance paper's performance and appearance. Acrylate coatings refer to coatings that contain acrylic polymers or acrylic resins. These coatings are applied to paper substrates for a variety of purposes. For example, acrylate coatings can improve the gloss and smoothness of paper and provide a protective layer on the paper, making it more resistant to moisture, dirt, and wear. Other benefits to acrylate coatings can include enhancing the adhesion of inks to paper surfaces, and improvements of printability of paper, allowing for better color reproduction and overall print quality. Furthermore, acrylates tend to dry quickly, which is essential in high-speed printing processes.

Overall, the use of acrylate coatings on paper provides a range of benefits, depending on the specific needs of the application. These coatings can be customized to achieve different visual and functional properties, making them a versatile choice for various printing and packaging applications.

Polyvinyl alcohol has been used as a steric stabilizer, protective colloid, or polymerizable surfactant in the emulsion polymerization for vinylic monomers, such as vinyl acetate, vinyl pyrrolidone, vinyl neodecanoate, and vinyl chloride. The application of polyvinyl alcohol in acrylate emulsion polymerization, on the other hand, has been found to be impossible on an industrial scale due to severe particle-particle coagulation or gelling due to the fast-grafting rate of acrylate monomers onto the abundant acetate groups of the polyvinyl alcohol.

Due to the advantageous properties, availability, safety, and functionality of polyvinyl alcohol, it would be desirable to use polyvinyl alcohol as a steric stabilizer, protective colloid, or polymerizable surfactant in emulsion polymerization for acrylate monomers, but a need exists to prevent particle-particle coagulation and gelling that occurs when polyvinyl alcohol is used with acrylate monomers.

Accordingly, a need exists for an acrylate dispersion copolymer in which polyvinyl alcohol is used as a steric stabilizer, protective colloid, or polymerizable surfactant, to produce paper coatings that enhance the paper's performance and appearance, and for other applications.

### SUMMARY OF THE PRESENT INVENTION

A feature of the present invention is to provide a polyvinyl alcohol acrylate dispersion copolymer in a cost-efficient manner.

Another feature of the present invention is to provide a polyvinyl alcohol acrylate dispersion copolymer that is storage stable over long periods of time.

An additional feature of the present invention is to provide a stable latex or dispersion of polyvinyl alcohol and acrylate copolymer without using other vinylic monomers.

Another feature of the present invention to provide a stable latex or dispersion of polyvinyl alcohol and acrylate copolymer, without using other vinylic monomers, and without using steric stabilizers other than the polyvinyl alcohol.

Another feature of the present invention is to provide a stable latex or dispersion of polyvinyl alcohol and acrylate copolymer to be used as a coating composition for paper or paper board products.

Additional features and advantages of the present invention will be set forth in part in the description that follows, and in part will be apparent from the description, or can be learned by practice of the present invention. The objectives and other advantages of the present invention will be realized and attained by means of the formulations, elements, and combinations particularly pointed out in the description and appended claims.

To achieve these and other advantages and in accordance with the purposes of the present invention, as embodied and broadly described herein, the present invention, in part, relates a reactive aqueous solution for emulsion polymerization. The reactive aqueous solution comprises: an acryl monomer; a partially hydrolyzed polyvinyl alcohol having acetate groups and hydroxyl groups and having a degree of hydrolysis of at least 50 mol %; one or more water-soluble monomers selected from a carboxylic acid monomer and an amide monomer; and water. Herein, by “acryl monomer,” what is meant is an ester of an organic acid monomer, for example, an ester of an unsaturated carboxylic acid monomer, an ester of acrylic acid, an ester of methacrylic acid, an acrylate monomer, a methacrylate monomer, or a combination thereof. Exemplary acryl monomers can include acids and esters that contain active unsaturation and are capable of undergoing free radical polymerization. The one or more water-soluble monomers are present in the reactive aqueous solution in an amount of from 0.5% by volume to 4.0% by volume, based on the total volume of the reactive aqueous solution. The amount of acryl monomer, by weight, based on the total weight of the reactive aqueous solution, is equal to or greater than the amount by weight of the partially hydrolyzed polyvinyl alcohol. Furthermore, the acryl monomer and the partially hydrolyzed polyvinyl alcohol are present in the reactive aqueous solution in amounts that provide, upon copolymerization, a stable dispersion of a covalently bonded polyvinyl alcohol acrylate copolymer that has at least three different types of repeating units.

It has been found, according to the present invention, that polyvinyl alcohol can be used as a steric stabilizer, protective colloid, or polymerizable surfactant in emulsion polymerization for acrylate monomers, whereby severe particle-particle coagulation and gelling can be avoided. Severe particle-particle coagulation and gelling can be avoided when the amount of acryl monomer, by weight, based on the total weight of a reactive aqueous solution, is present in a % by weight ratio, with respect partially hydrolyzed polyvinyl alcohol, within the range of from 10% to 90%. According to the present invention, severe particle-particle coagulation and gelling can be avoided when the amount of acryl monomer, by weight, based on the total weight of a reactive aqueous solution, is kept equal to or greater than the amount by weight of partially hydrolyzed polyvinyl alcohol. Desirably, resulting dispersions made from such reactive aqueous solutions do not exhibit the severe particle-particle coagulation and gelling that typically occurs according to previous attempts, due to the fast-grafting rate of acrylate monomers onto abundant acetate groups of polyvinyl alcohol.

The present invention further relates to a stable dispersion comprising a reaction product of a reactive aqueous solution as described herein, wherein the stable dispersion comprises a covalently bonded polyvinyl alcohol acrylate copolymer that has at least three different types of repeating units. The copolymer can, for example, be present in the stable dispersion as particles having a median particle size distribution of from 0.05 micron to 10 microns.

The present invention further relates to a diluted stable dispersion comprising a stable dispersion, as described herein, diluted with water. The diluted stable dispersion can have a weight ratio of water to copolymer of from 10:1 to 100:1.

The present invention further relates to a paper or paperboard product comprising paper or paperboard that is at least partially coated with the diluted stable dispersion.

The present invention further relates to a stable dispersion comprising a reaction product of a reactive aqueous solution as described herein, wherein the stable dispersion comprises a covalently bonded polyvinyl alcohol acrylate copolymer that has at least four different types of repeating units. The copolymer can, for example, be present in the stable dispersion as particles having a median particle size distribution of from 0.05 micron to 10 microns.

The present invention further relates to a method of forming a stable dispersion. The method can involve reacting, through emulsion polymerization, a reactive aqueous solution as described herein, to copolymerize (1) the acryl monomer, (2) the partially hydrolyzed polyvinyl alcohol, and (3) the one or more water-soluble monomers. These three different components can be copolymerized together to form a stable dispersion of a covalently bonded polyvinyl alcohol acrylate copolymer that has at least three different types of repeating units.

The present invention further relates to a latex dispersion of a copolymer in water. The copolymer can comprise three or more different types of repeating monomeric units and can be the emulsion polymerization product of (1) an acryl monomer, (2) a partially hydrolyzed polyvinyl alcohol having a degree of hydrolysis of from 72 mol % to 96 mol %, and (3) one or more water-soluble monomers selected from a carboxylic acid monomer and an amide monomer. The acryl monomer can be an ester of an unsaturated carboxylic acid monomer, an ester of acrylic acid, an ester of methacrylic acid, an acrylate monomer, a methacrylate monomer, or a combination thereof. The one or more water-soluble monomers can be present in the latex dispersion, as reacted monomeric units, in an amount of from 0.5% by volume to 4.0% by volume, based on the total volume of the latex dispersion. The amount of reacted monomeric units of the acryl monomer, in the latex dispersion, can be, by weight, equal to or greater than the amount by weight of reacted monomeric units of the partially hydrolyzed polyvinyl alcohol in the latex dispersion. The amount of acryl monomer, by weight, based on the total weight of a reactive aqueous solution, can be present in a % by weight ratio, with respect partially hydrolyzed polyvinyl alcohol, within the range of from 10% to 90%. The latex dispersion can be free of any other copolymerizable acrylate surfactants besides the partially hydrolyzed polyvinyl alcohol.

It is to be understood that both the foregoing general description and the following detailed description are exemplary and explanatory only and are intended to provide a further explanation of the present invention, as claimed.

### DETAILED DESCRIPTION OF THE PRESENT INVENTION

A reactive aqueous solution is provided for an emulsion polymerization reaction that forms a polyvinyl alcohol acrylate dispersion copolymer. The reactive aqueous solution can comprise an acryl monomer, a partially hydrolyzed polyvinyl alcohol, one or more water-soluble monomers, and water.

Herein, by “acryl monomer,” what is meant is an ester of an unsaturated carboxylic acid monomer, an ester of acrylic acid, an ester of methacrylic acid, an acrylate monomer, a methacrylate monomer, or a combination thereof. Exemplary acryl monomers can include acids and esters, that contain active unsaturation and are capable of undergoing free radical polymerization. The partially hydrolyzed polyvinyl alcohol can be formed from polyvinyl acetate but wherein not all of the acetate groups are substituted with hydroxyl groups. For example, the partially hydrolyzed polyvinyl alcohol can have acetate groups and hydroxyl groups and can exhibit a degree of hydrolysis of at least 50 mol %, for example, from 60 mol % to 99 mol %, from 72 mol % to 96 mol %, or from 80 mol % to 90 mol %. The reactive aqueous solution can be free of any other copolymerizable surfactants for acrylates, besides the partially hydrolyzed polyvinyl alcohol. The partially hydrolyzed polyvinyl alcohol can be the only acrylate surfactant in the reactive aqueous solution.

The one or more water-soluble monomers can be selected from carboxylic acid monomers, and/or amide monomers, or a combination thereof. The one or more water-soluble monomers can comprise a carboxylic acid monomer. A copolymer resulting from the inclusion of a carboxylic acid monomer can comprise carboxylic acid groups. The copolymer can be configured to be convertible, for example, from a water-insoluble form in a dispersion, to a water-soluble form in a solution. A method of converting the water-insoluble copolymer to a water-soluble form can comprise adding an alkali metal-containing agent in an amount sufficient to convert the copolymer to a substantially water-soluble or completely water-soluble form.

The one or more water-soluble monomers can be present in the reactive aqueous solution in an amount of from 0.25% by volume to 6.0% by volume, from 0.4% by volume to 5.5% by volume, from 0.5% by volume to 5% by volume, from 0.75% by volume to 4.5% by volume, from 1% by volume to 4% by volume, from 1% by volume to 3.5% by volume, from 1% by volume to 3% by volume, from 1% by volume to 2% by volume, or any range based upon any two of the values described herein, based on the total volume of the reactive aqueous solution.

As an example, the one or more water-soluble monomers can be present in the reactive aqueous solution in an amount of from 0.5 to 4 parts by weight based on 100 parts by weight of the water, for example, from 1 part to 3 parts by weight, or from 1.5 parts to 2.5 parts by weight, based on 100 parts by weight water, or in a parts by weight range based on any two of the values described herein.

The amount of acryl monomer, by weight, based on the total weight of a reactive aqueous solution, can be present in a % by weight ratio, with respect partially hydrolyzed polyvinyl alcohol, within the range of from 10% to 90%. The amount of acryl monomer, by weight, based on the total weight of the reactive aqueous solution, can be equal to or greater than the amount by weight of the partially hydrolyzed polyvinyl alcohol. The acryl monomer and the partially hydrolyzed polyvinyl alcohol can be present in the reactive aqueous solution in amounts that provide, upon copolymerization, a stable dispersion of a covalently bonded polyvinyl alcohol acrylate copolymer. The covalently bonded polyvinyl alcohol acrylate copolymer can have at least three different types of repeating units, for example, four different types of repeating units, five different types of repeating units, or more.

The reactive aqueous solution can be free of any other copolymerizable surfactants besides the partially hydrolyzed polyvinyl alcohol. The partially hydrolyzed polyvinyl alcohol can be the only acrylate surfactant in the reactive aqueous solution. The partially hydrolyzed polyvinyl alcohol acts as a steric stabilizer for the formed dispersion particles, as the hydroxyl groups of the covalently bonded polyvinyl alcohol molecules can protect the developing polymer particles from coalescing or coagulating into one solid mass or gel.

The acryl monomer can be present in the reactive aqueous solution in an amount of from 1 part by weight to 50 parts by weight based on 100 parts by weight of water, for example, from 2 parts by weight to 45 parts by weight, from 3 parts by weight to 40 parts by weight, from 5 parts by weight to 35 parts by weight, from 10 parts by weight to 30 parts by weight, from 15 parts by weight to 25 parts by weight, or from 20 parts by weight to 24 parts by weight, based on 100 parts by weight water, or in another weight range based upon any two of the values described above.

The partially hydrolyzed polyvinyl alcohol can be present in the reactive aqueous solution in an amount of from 1 part by weight to 30 parts by weight based on 100 parts by weight of the water, for example, from 2 parts by weight to 25 parts by weight, from 3 parts by weight to 20 parts by weight, from 4 parts by weight to 15 parts by weight, from 5 parts by weight to 12 parts by weight, or from 8 parts by weight to 10 parts by weight, based on 100 parts by weight water, or in another weight range based upon any two of the values described above.

As mentioned above, the amount of acryl monomer can be the same amount, or greater, by weight, as the amount of the partially hydrolyzed polyvinyl alcohol. Based on 100 parts by weight water, the amount of acryl monomer can be 1 part by weight greater than the amount of partially hydrolyzed polyvinyl alcohol, can be 2 parts by weight greater than the amount of partially hydrolyzed polyvinyl alcohol, can be 3 parts by weight greater than the amount of partially hydrolyzed polyvinyl alcohol, can be 5 parts by weight greater than the amount of partially hydrolyzed polyvinyl alcohol, can be 10 parts by weight greater than the amount of partially hydrolyzed polyvinyl alcohol, can be 15 parts by weight greater than the amount of partially hydrolyzed polyvinyl alcohol, can be 20 parts by weight greater than the amount of partially hydrolyzed polyvinyl alcohol, can be 30 parts by weight greater than the amount of partially hydrolyzed polyvinyl alcohol, or the like. These amounts can be also “at least” amounts, such as at least 1 part by weight greater than the amount of partially hydrolyzed polyvinyl alcohol, and so on.

The acryl monomer can comprise an acrylate monomer. The acrylate monomer can be selected from 2-hydroxyethyl methacrylate, hydroxypropyl methacrylate, hydroxypropyl acrylate, 2-ethylhexyl acrylate, 2-hydroxyethyl acrylate, 4-hydroxybutyl acrylate, ethyl acrylate, methyl acrylate, methyl methacrylate, butyl acrylate, 2-hydroxyethyl acrylate, stearyl acrylate, stearyl methacrylate, isobutyl methacrylate, dimethyl amino ethyl acrylate, dimethyl amino ethyl methacrylate, acrylonitrile, 2-octyl acrylate, iso-butyl acrylate, tert-butyl acrylate, 2-dimethylamino ethyl methacrylate, 3-dimethylamino propyl methacrylate, N-isopropyl meth acrylamide, 2-trimethylammonium ethyl methacrylate chloride, 3-trimethylammonium propyl meth acrylamide chloride, and/or ureido methacrylate. The acrylate monomer can be, more specifically, selected from hydroxyethyl methacrylate, hydroxypropyl methacrylate, 2-ethylhexyl acrylate, ethyl acrylate, ureidomethacrylate, and/or 4-hydroxybutyl acrylate.

The acryl monomer can be considered a water-soluble acryl monomer that is soluble in water at 25° C. and one atmosphere pressure. The acryl monomer can be completely water-soluble or substantially water-soluble, that is, can have greater than 99 wt % water solubility. Examples of water-soluble acryl monomers can include, but are not limited to, 2-hydroxyethyl methacrylate, hydroxypropyl methacrylate, hydroxypropyl acrylate, 2-hydroxyethyl acrylate, 4-hydroxybutyl acrylate, or any combinations thereof.

The reactive aqueous solution can further comprise a water-miscible acrylate monomer that differs from the acryl monomer. For example, a water-miscible acrylate monomer that has a low aqueous solubility compared with the acryl monomer, can be considered water-insoluble yet miscible in water at 25° C. and one atmosphere pressure. In such cases, that is, where the reactive aqueous solution further comprises a water-miscible acrylate monomer that differs from the acryl monomer, the reactive aqueous solution might not technically remain a solution, wherein every component is completely solubilized therein, but is nonetheless still referred to herein as a reactive aqueous solution.

The water-miscible acrylate monomer can have a very low solubility in water, as compared with the acryl monomer, or can be considered water-insoluble yet miscible in water at 25° C. and one atmosphere pressure. The water-miscible acrylate monomer can comprise, but is not limited to, ethyl acrylate, methyl acrylate, methyl methacrylate, butyl acrylate, 2-ethylhexyl acrylate, stearyl acrylate, stearyl methacrylate, isobutyl methacrylate, acrylonitrile, 2-octyl acrylate, iso-butyl acrylate, tert-butyl acrylate, cyclohexyl acrylate, methoxyethyl acrylate, isoamyl acrylate, or any combinations thereof. Such acrylate monomers can be miscible with water in the presence of surfactants, such as PVOH or an alkyl sulphonate. With regard to the water solubility of the water-miscible acrylate monomers, ethyl acrylate, methyl acrylate, and methyl methacrylate can have very small water miscibility, for example with each having a solubility value of from 1.0 mg to 1.0 gram per 100 ml of water, at one atmosphere.

For compositions comprising both, the water-soluble acryl monomer and the water-miscible acrylate monomer can both be capable of polymerizing to water insoluble polymers. The water-soluble acryl monomer and the water-miscible acrylate monomer can be selected based on their abilities to graft onto polyvinyl alcohol and convert an otherwise copolymer solute into a copolymer dispersion.

The monomeric units of the polyvinyl alcohol acrylate dispersion copolymer can be only acryl monomer units and one or more water soluble monomer units selected from the group consisting of carboxylic acid monomers and/or amide monomers. Put another way, the polyvinyl alcohol acrylate dispersion copolymer can be in complete absence of vinylic monomers. With the present invention, the percent of acryl monomers used in the graft-polymerization can be, for instance, 70% by number or more, such as from 75% by number to 99% by number, or 80% by number to 99% by number or from 85% by number to 98% by number, based on total number of grafting sites on the polyvinyl alcohol main chain. The percent of water-soluble monomers used in the graft-polymerization can be, for instance, 1% by number or more, such as from 2% by number to 20% by number, or 5% by number to 15% by number or from 12% by number to 14% by number, based on total number of grafting sites on the polyvinyl alcohol main chain

The reactive aqueous solution described herein can be reacted, for example, through emulsion polymerization, to form a stable dispersion or latex dispersion. The stable dispersion can comprise a reaction product of the reactive aqueous solution. The stable dispersion can comprise a covalently bonded polyvinyl alcohol acrylate copolymer that has at least three different types of repeating units. When the reactive aqueous solution additionally comprises a water-insoluble, water-miscible acrylate monomer that differs from the acryl monomer, the resulting stable dispersion comprises a covalently bonded polyvinyl alcohol acrylate copolymer that has at least four different types of repeating units. When five different monomers are included in the reactive aqueous solution, the resulting copolymer can have five different types of repeating units, and so on. The copolymer can be present in the stable dispersion as particles having a median particle size distribution of from 0.05 micron to 10 microns, for example, a median particle size distribution of from 0.1 micron to 5 microns. Particle size measurements can be determined by measuring randomly 50 particles. The particle size measurement can be achieved using laser diffraction, or dynamic light scattering, or dynamic image analysis techniques, such as an HORIBA LA-960 or LA-300 Laser Particle Size Analyzer, or a HORIBA SZ-100 Nanopartica Instrument, or an HORIBA Camsizer or Camsizer X2 dynamic image analysis system.

The stable dispersion can be stable for at least one freeze-thaw stability cycle. The stable dispersion can exhibit a shelf-life stability of at least 6 months at a temperature of 25° C. and a pressure of 1 atmosphere. The stable dispersion can be diluted with water to form a diluted stable dispersion. The diluted stable dispersion can have a weight ratio of water to copolymer, of, for example, from 6:1 to 500:1, from 8:1 to 200:1, or from 10:1 to 100:1. The diluted product can be applied to a material or article by any suitable method, for example, spraying, brush coating, doctoring, or the like. The full-strength or diluted product can be used to coat a material, to impregnate a material, to soak a material, or the like. The material can be an article, for example, a textile, a paper product, a paperboard product, a web-formed product, a plastic article, or the like.

According to the present invention, a paper or paperboard product is also provided and can comprise paper or paperboard that is at least partially coated with a diluted stable dispersion as described herein. The coated paper or paperboard product can result in a plastic/paper composite. The polyvinyl alcohol acrylate dispersion of the present invention allows for the benefits of an acrylate copolymer coating while being provided at a minimal coating level.

As an option, the stable dispersion can comprise a reaction product of a reactive aqueous solution comprising an acryl monomer, a partially hydrolyzed polyvinyl alcohol, one or more water-soluble monomers, and water, as described herein, and the reaction product of a water-miscible acrylate monomer that differs from the acryl monomer. The water-miscible acrylate monomer can be of lower aqueous solubility as compared with the acryl monomer. The water-miscible acrylate monomer can be considered insoluble in water, for example, insoluble in water at 25° C. and one atmosphere pressure. The water-miscible acrylate monomer is also referred to herein as a water-miscible, water-insoluble acrylate monomer that differs from the acryl monomer.

As mentioned herein, the stable dispersion can comprise a covalently bonded polyvinyl alcohol acrylate copolymer that has at least four different types of repeating units, for example, that also includes a water-miscible, water-insoluble acrylate monomer that differs from the acryl monomer, as described herein. The water-miscible, water-insoluble acrylate monomer that differs from the acryl monomer can be selected from 2-hydroxyethyl methacrylate, 2-hydroxyethyl ethacrylate, 2-methylhexyl acrylate, 2-ethylhexyl acrylate, and/or butyl acrylate. The copolymer having at least four different types of repeating units can be present in the stable dispersion as particles having a median particle size distribution of from 0.05 micron to 10 microns, for example, having a median particle size distribution of from 0.1 micron to 5 microns or from 0.75 micron to 3 microns.

A method of forming a stable dispersion or latex dispersion is also provided. The method involves reacting, for example, through an emulsion polymerization, a reactive aqueous solution as described herein, to copolymerize (1) the acryl monomer, (2) the partially hydrolyzed polyvinyl alcohol, and (3) the one or more water-soluble monomers, together. The reaction forms a stable dispersion of a covalently bonded polyvinyl alcohol acrylate copolymer that has at least three different types of repeating units. The method can comprise mixing the water with the partially hydrolyzed polyvinyl alcohol, to form a first mixture. The method can comprise heating the first mixture. The method can comprise adding the one or more water-soluble monomers to the first mixture to form a second mixture. The method can comprise adding the acryl monomer to the second mixture. The method can comprise adding one or more free radical initiators. The method can comprise batch or semi-continuously feeding the one or more water-soluble monomers to the first mixture to form the second mixture. The method can comprise batch or semi-continuously feeding the acryl monomer to the second mixture.

In cases where the one or more water-soluble monomers comprise a carboxylic acid monomer, the copolymer can comprise carboxylic acid groups. For such cases, the method can comprise adding an alkali metal-containing agent in an amount sufficient to convert the copolymer to a substantially water-soluble or completely water-soluble form. By so doing, the method can comprise changing or converting the stable dispersion or latex dispersion into a solution.

The method can comprise diluting a stable dispersion as described herein, with water, to form a diluted product. The diluted product can be diluted by any desired dilution ratio, for example, to obtain a weight ratio of water to copolymer of from 10:1 to 100:1. The method can comprise coating and/or impregnating at least a portion of a paper or paperboard with the diluted product, to form a coated and/or impregnated product. The method can comprise drying a coated and/or impregnated product to form a dried product. Products, for example, paper or paperboard products, are provided that comprise the dried products made according to a method as described herein.

As part of the present invention, a latex dispersion of a copolymer in water, is provided. The copolymer can comprise three or more different types of repeating monomeric units. The latex dispersion can be the emulsion polymerization product of (1) an acryl monomer, (2) a partially hydrolyzed polyvinyl alcohol having a degree of hydrolysis of from 72 mol % to 96 mol %, and (3) one or more water-soluble monomers selected from a carboxylic acid monomer and/or an amide monomer. The acryl monomer can be an ester of an unsaturated carboxylic acid monomer, an ester of acrylic acid, an ester of methacrylic acid, an acrylate monomer, a methacrylate monomer, or any combinations thereof. The one or more water-soluble monomers can be present in the latex dispersion, as reacted monomeric units, in an amount of from 0.5% by volume to 4.0% by volume, based on the total volume of the latex dispersion. The amount of reacted monomeric units of the acryl monomer, in the latex dispersion, can be, by weight, equal to or greater than the amount of reacted monomeric units of the partially hydrolyzed polyvinyl alcohol in the latex dispersion. The latex dispersion can be free of any other copolymerizable acrylate surfactants besides the partially hydrolyzed polyvinyl alcohol. The latex dispersion of the copolymer in water can encompass any of the embodiments of the stable dispersion described herein.

As an option, the one or more water-soluble monomers comprises a carboxylic acid monomer. Once formed, the copolymer comprises carboxylic acid groups. The copolymer exhibits a convertibility that enables the copolymer to become completely water-soluble, for example, to exhibit at least 90% water-solubility at 25° C. and one atmosphere. The convertibility can be achieved by adding to the latex dispersion an alkali metal-containing agent that converts the carboxylic acid groups of the copolymer into corresponding alkali metal salts. As a result, the latex dispersion can be converted into a solution. Greater details about convertibility, including methods, agents, conditions, and the like, that can be implemented according to the present invention, are described in U.S. Pat. No. 11,345,807 to Moustafa et al, and U.S. Pat. No. 11,560,443 to Moustafa et al., both incorporated herein in their entireties by reference.

The stable dispersion of the polyvinyl alcohol acrylate dispersion copolymer can comprise a copolymer made from an acryl monomer unit and one or more water-soluble monomer units grafted to a polyvinyl alcohol main chain (a graft polymer).

Unless otherwise indicated, reference herein to “a stable dispersion” or “the stable dispersion” is a reference to the dispersion containing the polyvinyl alcohol acrylate dispersion copolymer as described herein. Unless otherwise indicated, reference herein to “a copolymer” or “the copolymer” is a reference to the polyvinyl alcohol acrylate copolymer contained within a dispersion as described herein.

“Monomer” as used herein refers to a molecule that may be capable of reacting to form polymers by free radical addition polymerization of ethylenically unsaturated double bonds.

“Monomeric unit” or “unit” as used herein refers to a chemically bound unit in a polymer or copolymer that is derived from a monomer.

It is to be understood that, while the monomers or units of monomers are described or referred to herein, the copolymer itself has the radical version of each monomer and thus the radical version of each monomer is referred to herein as a monomeric unit or unit of the monomer.

The copolymer of the present invention comprises, consists essentially of, consists of, includes, or is, a polyvinyl alcohol main chain having a plurality of side chains grafted thereon, that is grafted to the polyvinyl alcohol main chain. One or more of the side chains from the plurality of side chains can comprise, consist essentially of, consist of, or include: one or more acryl monomer units and one or more water soluble monomer units selected from a carboxylic acid unit, an amide unit, or a combination thereof.

Prior to a grafting of monomers onto the main chain, the polyvinyl alcohol main chain, in unreacted form, can have a molecular weight distribution of from about 5,000 Daltons to about 1,000,000 Daltons. In this example, the molecular weight distribution of the polyvinyl alcohol main chain, in free, unreacted form, is a monomodal, bimodal, or multimodal, molecular weight distribution. The polyvinyl alcohol main chain, in free, unreacted form, can have a weight-average molecular weight of from 2,000 Daltons to 500,000 Daltons, and/or can have a number-average molecular weight of from about 1,000 Daltons to about 50,000 Daltons. Accordingly, the polyvinyl alcohol main chain, in free, unreacted form, can have a polydispersity, Mw/Mn, of from 1.1 to 10, from 2 to 7, or from 3 to 6.

The polyvinyl alcohol main chain, in free, unreacted form, can have a degree of hydrolysis of from about 50 mol % to about 98 mol % or other amounts below or above this range. All values between 50 mol % and 98 mol % are included in this range, with the end points included. Thus, the range of the degree of hydrolysis can be from 65 mol % to 95 mol %, from 74 mol % to 90 mol %, from 74 mol % to 88 mol %, from 76 mol % to 95 mol %, from 76 mol % to 90 mol %, and from 76 mol % to 88 mol %. Since all values between 74 mol % and 98 mol % are included in this range, the degree of hydrolysis can be 74 mol %, 75 mol %, 76 mol %, 77 mol %, 78 mol %, 79 mol %, 80 mol %, 81 mol %, 82 mol %, 83 mol %, 84 mol %, 85 mol %, 86 mol %, 87 mol %, 88 mol %, 89 mol %, 90 mol %, 91 mol %, 92 mol %, 93 mol %, 94 mol %, 95 mol %, 96 mol %, 97 mol %, and 98 mol %, with decimals and fractions thereof included.

The degree of hydrolysis can be an indicator as to how many free alcohol moieties (—OH) are present on the main chain of the polyvinyl alcohol main chain. The synthesis of polyvinyl alcohol first involves the polymerization of vinyl acetate, which forms polyvinyl acetate. Thereafter, acetate moieties (—O—(CO)—CH₃) are replaced with alcohol moieties via a hydrolysis reaction. Thus, as used herein, the “degree of hydrolysis” can refer to the mol % of acetate moieties that are replaced with alcohol moieties upon transesterification of the polyvinyl acetate. Thus, as an example, 74 mol % of acetate moieties are replaced with alcohol moieties for a polyvinyl alcohol main chain characterized by a degree of hydrolysis of 74 mol %.

As an option, the polyvinyl alcohol main chain, in free, unreacted form, can be extra functionalized with ethylene segments. When polyvinyl alcohol is functionalized by ethylene segments, it means that ethylene groups have been introduced into the polymer chain. If ethylene segments are included along the polyvinyl alcohol main chain, they can be present in an amount, by weight, of from 0.5% to 15%, from 1% to 12%, from 1% to 10%, from 1% to 8%, from 2% to 7%, from 3% to 6%, or from 4% to 5%, based on the total weight of the polyvinyl alcohol main chain, or they can be present in a range of amounts based upon any two of the values described above.

As an option, a solution containing 4% by weight of polyvinyl alcohol main chain, in free, unreacted form, and 96% by weight can have a viscosity of 1-50 centipoise (cP) at 25° C. and one atmosphere pressure. For example, the viscosity of the 4% polyvinyl alcohol solution can be from 2 cP to 40 cP, from 3 cP to 40 cP, from 4 cP to 35 cP, from 5 cP to 30 cP, from 8 cP to 25 cP, from 10 cP to 20 cP, from 12 cP to 18 cP, or from 14 cP to 16 cP, at 25° C. and one atmosphere pressure, or within another range based upon any two of the values described above. The viscosity of a 4% polyvinyl alcohol solution can vary depending on the molecular weight of the polyvinyl alcohol main chain component.

The polyvinyl alcohol main chain, in unreacted form, can be one or more of a POVAL (Kurary Co., Ltd. of Kurashiki, Japan) polyvinyl alcohol selected from 5/88, 3/80 3/82, 3/85, 4/85, 4/88, 5/82, 6/88, 13/88, 3/88, 5/74, 5/88, 8/88, and/or RS2117, one or more of a SELVOL™ (Sekisui Specialty Chemicals America, LLC of Dallas, Texas) polyvinyl alcohol selected from 5002, 513, 518, 418, 425, 443, 203, 523, 205, and/or 540, or any combinations thereof.

As mentioned above, the present invention utilizes one or more water soluble monomers selected from a carboxylic acid monomer and an amide monomer. Accordingly, the present invention can use both carboxylic acid monomers and amide monomers. In the present invention, the carboxylic acid can comprise, can consist essentially of, can consist of, can include, or is, at least one of acrylic acid and methacrylic acid. The amide can be an unsaturated amide. The amide can be a saturated amide. The amide can comprise, can consist essentially of, can consist of, can include, or is, at least one of acrylamide, methacrylamide, dimethyl acrylamide, diethyl acrylamide, dipropyl acrylamide, 2-acrylamido-2-methyl propane sulphonic acid, N-t-butylacrylamide, N-isopropyl acrylamide, N-isopropyl meth acrylamide, and 3-trimethylammonium propyl meth acrylamide chloride.

Alternative water-soluble monomers that can also, or instead, be used, include 2-trimethylammonium ethyl methacrylate chloride, dimethyl amino ethyl acrylate, and diallyl dimethyl ammonium chloride.

The water-soluble monomers act as reaction kinetics regulators and/or polyvinyl alcohol molecular chain modifiers. One monomer or a combination of monomers can be used for the reaction kinetics control. By acting as reaction kinetics regulators and/or polyvinyl alcohol molecular chain modifiers, the water-soluble monomers, which can be fed to the reactive aqueous solution in batches, semi-batches, or continuously, hinder or stop particle-particle coagulation or gelling during the emulsion polymerization. The water-soluble monomers can graft to a portion of the pendant acetate groups of the polyvinyl alcohol, at the same time they can copolymerize with the acryl monomer in the aqueous phase, thus reducing the aggressive grafting rate onto the PVOH acetate groups; in other words, it is believed that the water-soluble monomers compete with acetate groups of PVOH for copolymerization reaction. As such, excessive grafting of acryl monomers to the polyvinyl alcohol is prevented, which in turn prevents excessive crosslinking or gelling of the reactive aqueous solution. The water-soluble monomers can graft, for example, to 5%, 10%, 25%, 50%, 75%, 90% or 95% (or any range formed from two of these %) of the pendant acetate groups of the polyvinyl alcohol at the same time they can copolymerize with the acryl monomer in the aqueous phase, thus reducing the aggressive grafting rate onto the PVOH acetate groups; in other words, the water-soluble monomers compete with acetate groups of PVOH for copolymerization reaction.

The copolymer of the present invention is dispersed in an aqueous solution and forms a stable aqueous dispersion that does not exhibit coagulation or precipitation of the copolymer within a period of at least 6 months when stored at 25° C. and 1 atmosphere of pressure. Preferably, the stable dispersion does not exhibit coagulation or precipitation of the grafted polyvinyl alcohol polymer within a period of at least one year at 25° C. and 1 atmosphere of pressure, more preferably, at least two years under these same conditions. As used herein, the term “coagulation” can mean an irreversible combination or aggregation of individual grafted polyvinyl alcohol copolymer particles in the aqueous dispersion to form a clot or mass of several or multiple grafted polyvinyl alcohol copolymer dispersions.

The stable dispersion or latex of the present invention can have a viscosity of from 50 cP to 5000 cP, from 60 cP to 4900 cP, from 70 cP to 4800 cP, from 80 cP to 4700 cP, from 90 cP to 4600 cP, from 100 cP to 4500 cP, from 150 cP to 4400 cP, from 200 cP to 4300 cP, from 250 cP to 4400 cP, from 300 cP to 4200 cP, from 400 cP to 4100 cP, from 500 cP to 4000 cP, from 600 cP to 3900 cP, from 700 cP to 3800 cP, from 800 cP to 3700 cP, from 900 cP to 3600 cP, from 1000 cP to 3500 cP, from 1100 cP to 3400 cP, from 1200 cP to 3300 cP, from 1300 cP to 3200 cP, from 1400 cP to 3100 cP, from 1500 cP to 3000 cP, from 1600 cP to 2900 cP, from 1700 cP to 2800 cP, from 1800 cP to 2700 cP, from 1900 cP to 2600 cP, from 2000 cP to 2500 cP, from 2100 cP to 2400 cP, from 2200 cP to 2300 cP, at 25° C. and 1 atmosphere of pressure, or in another range based upon any two of the values described above. The viscosity of the solutions herein can be measured using centipoise (cPS) at standard temperature and pressure (25 deg C and 1 atm). Viscosity measurements can be carried out according to one of the five methods: the capillary viscometer, the flow cup, the rotational viscometer, the rolling ball viscometer and the drawing ball viscometer. A viscometer can be used, such as one from Elcometer, for instance, using device default settings. The viscosity can be a Brookfield viscosity at 25 deg C.

The stable dispersion or latex of the present invention includes particles dispersed within an aqueous medium. The particles are the polyvinyl alcohol acrylate copolymers. The median particle size distribution of the particles can be from 0.05 micron to 10 microns, for example, a median particle size distribution of from 0.1 micron to 9.5 microns, from 0.25 micron to 9 microns, from 0.5 micron to 8.5 microns, from 0.75 micron to 8 microns, from 1 micron to 7 microns, from 1.5 microns to 6.5 microns, from 2 microns to 6 microns, from 2.5 microns to 5.5 microns, from 3 microns to 5 microns, from 3.5 microns to 4.5 microns, from 3 microns to 4 microns, or another range of microns based upon any two of the values described above.

Other properties of the copolymer of the present invention include the weight-average molecular weight and the number-average molecular weight of the copolymer. For instance, the copolymer of the present invention can have a weight-average molecular weight of from about 50,000 Daltons to about 1,500,000 Daltons, such as from 100,000 Daltons to 1,000,000 Daltons, or from 250,000 Daltons to 750,000 Daltons. The copolymer of the present invention can have a number-average molecular weight of from 2,000 Daltons to about 50,000 Daltons. The weight-average molecular weight and the number-average molecular weight of the copolymer can be measured, for example, by gel permeation chromatography or other acceptable techniques.

The polydispersity of the copolymer is generally defined as the weight-average molecular weight of a copolymer divided by the number-average molecular weight of the copolymer polymer (PD=Mw/Mn). The copolymer of the present invention can have a polydispersity, Mw/Mn, of at least 1.0, of at least 1.5, of at least 2.0, or the like.

In one aspect, the stable dispersion can comprise, can consist of, can consist essentially of, or can include, 100 parts by weight of the aqueous phase and from 1 part by weight to 70 parts by weight, or more, of the copolymer, for example, from 10 parts by weight to 65 parts by weight copolymer of the present invention, where, in this formulation, the copolymer is dispersed in the aqueous phase. All values between 1 part by weight and 70 parts by weight are included in this range, with the end points included, and thus the range can be from 5 parts by weight to 65 parts by weight, from 10 parts by weight to 60 parts by weight, from 10 parts by weight to 55 parts by weight, from 12 parts by weight to 50 parts by weight, from 12 parts by weight to 45 parts by weight, from 12 parts by weight to 30 parts by weight, from 14 parts by weight to 25 parts by weight, from 14 parts by weight to 20 parts by weight, from 15 parts by weight to 18 parts by weight, from 15 parts by weight to 25 parts by weight, and from 15 parts by weight to 35 parts by weight. Since all values between 1 part by weight and 70 parts by weight are included in this range, the parts by weight can be, for instance, 2 parts by weight, 5 parts by weight, 10 parts by weight, 11 parts by weight, 12 parts by weight, 13 parts by weight, 14 parts by weight, 15 parts by weight, 16 parts by weight, 17 parts by weight, 18 parts by weight, 19 parts by weight, 20 parts by weight, 21 parts by weight, 22 parts by weight, 23 parts by weight, 24 parts by weight, 25 parts by weight, 26 parts by weight, 27 parts by weight, 28 parts by weight, 29 parts by weight, 30 parts by weight, 31 parts by weight, 32 parts by weight, 33 parts by weight, 34 parts by weight, 35 parts by weight, 36 parts by weight, 37 parts by weight, 38 parts by weight, 39 parts by weight, 40 parts by weight, 41 parts by weight, 42 parts by weight, 43 parts by weight, 44 parts by weight, 45 parts by weight, 46 parts by weight, 47 parts by weight, 48 parts by weight, 49 parts by weight, 50 parts by weight, 51 parts by weight, 52 parts by weight, 53 parts by weight, 54 parts by weight, 55 parts by weight, 56 parts by weight, 57 parts by weight, 58 parts by weight, 59 parts by weight, 60 parts by weight, 61 parts by weight, 62 parts by weight, 63 parts by weight, 64 parts by weight, 65 parts by weight, 66 parts by weight, 67 parts by weight, 68 parts by weight, 69 parts by weight, 70 parts by weight with decimals and fractions thereof included.

The stable dispersion does not exhibit coagulation or precipitation of the grafted polyvinyl alcohol polymer within a period of at least six months when stored at 25° C. and 1 atmosphere of pressure.

Alternatively, the stable dispersion is stable for a period of at least one year, or for a period of at least two years, when stored at 25° C. and 1 atmosphere of pressure. The terms “coagulation” and “precipitation,” herein, have the same definition as given above.

The polyvinyl alcohol acrylate dispersion copolymer of the present invention can have a pH of from about 2 to about 5 or from about 2 to about 3, and, when the formulation has such a pH, the copolymer can be in condensed form as discussed below. As another option, the formulation of the present invention can have a pH of from about 4 to about 5.5, and, when the formulation has this pH, the copolymer is in semi-condensed form as discussed below.

As a further option, the formulation of the present invention can have a pH of from about 5.5 to about 8, and, when the formulation has this pH, the copolymer can be considered to be in an amorphously-dissolved form as discussed below. The select monomers include, for example, hydroxyethyl methacrylate and hydroxypropyl methacrylate, and can include other hydrophilic monomers.

The copolymer is soluble in the aqueous phase of the formulation in an amount of at least 10 g/100g water. As an option, the maximum amount of the copolymer in the formulation of the present invention can be about 70 g/100 g water or higher. Other ranges within these limits are can also be used, such as: from 10 g/100 g water to 65 g/100 g water; from 12 g/100 g water to 55 g/100 g water; from 15 g/100 g water to 45 g/100 g water; from 15 g/100 g water to 40 g/100 g water; from 18 g/100 g water to 45 g/100 g water; from 18 g/100 g water to 40 g/100 g water; from 20 g/100 g water to 45 g/100 g water; from 20 g/100 g water to 40 g/100 g water. All numbers within these ranges are available, or decimals thereof or fractions thereof. The copolymers can be soluble in the aqueous phase by pH control, in amounts up to 10% by weight, i.e., 10 g of polymer in 90 g of water. In amounts of more than 10% by weight polymer in solution, the aqueous phase can become very viscous.

The formulation of the present invention, at these concentrations of copolymer in water, can be a highly concentrated product that reduces bulk for shipping and storage. Because the copolymer polymer is dispersible or soluble in the aqueous solution, without gelling or other viscosity issues, it is possible to have formulations having higher concentrations of the copolymer. An end-user of the concentrated product, such as a paper company or other user, can dilute the concentrate to a desired solids content for application as a coating solution. For higher solids contents of the copolymer in the aqueous phase, lower ratios of PVOH-to-acryl monomer can be used. The covalent bonding between PVOH and acryl monomers integrates the PVOH property of good film formation at minute concentration to the dispersion product; this new property integration enables less consumption of paper coatings or coat weight for various applications.

Some copolymers of the present invention are capable of being in condensed form when present in an aqueous solution having a pH of from about 2 to about 5 or from 2 to about 3 (e.g. 1.5 to 3.5, or 2 to 3.5, or 2.2 to 3, or 2.2 to 2.8, or 3 to 5, or 2 to 5, or 4 to 5, or 4 or 4.5 or 5), are capable of being in semi-condensed form when present in an aqueous solution having a pH of from about 4 to about 5.5 (e.g. 3.8 to 5.8, or 4.0 to 5.5, or 4.2 to 5.2), and are capable of being in amorphous form when present in an aqueous solution having a pH of from about 5.5 to about 8 (e.g. 5.3 to 8.5, or 5.5 to 8.3, or 5.5 to 7.5, or 5.8 to 8, or 6.0 to 7.5). All pH values between the ranges of about 2 to about 5, about 2 to about 3, about 4 to about 5.5, and about 5.5. to about 8, are included in these ranges, including the end points of the individual ranges. Specific copolymers exhibiting these properties include copolymers that have been copolymerized from hydroxyethyl methacrylate, hydroxypropyl methacrylate, and combinations thereof. pH measurements can be at 25° C. and 1 atmosphere of pressure and measured with a lab acceptable pH meter.

When the copolymer is in condensed form, individual copolymers are folded upon themselves, resulting in a tangled grouping of individual polymers clumped together to form copolymer particles. The folding of the individual copolymers occurs because the developed copolymers are water insoluble. The water insoluble copolymers do not precipitate or agglomerate due to the covalent bonding with PVOH which keeps the water insoluble particles suspended in water by the hydrophilic and hydrated polyvinyl alcohol arms radiating from the condensed particle.

When the copolymer is in condensed form, polymer particles can form in a water suspension. As an example, when the polymer is an aqueous dispersion having a pH of 2, the average particle size can be from 100 nm to 5,000 nm, from 100 nm to 200 nm, from 50 nm to 150 nm, and/or from 150 nm to 300 nm, with all values in this range being included, along with decimals of these values and fractions of these values. For instance, the average particle size can be about 170 nm. The particle size distribution can be multimodal, where, as an example the overall average particle size is 170 nm, where about 65% (by number) of the polymer particles having an average diameter of 470 nm and about 25% of the polymer particles having an average diameter of 50 microns. Particle sizes of the polymer can be determined via dynamic light scattering experiments. An exemplary lowest particle size diameter in the condensed form is 300 nm.

When the copolymer is in semi-condensed form, the larger, swelled polymer particles can form in solution. As an example, when the copolymer is an aqueous solution having a pH of 4.5, the average particle size can be from 175 nm to 375 nm, with all values in this range being included, along with decimals of these values and fractions of these values. For instance, the average particle size can be about 300 nm. The particle size can be multimodal, where, as an example the overall average particle size is 300 nm, where about 95% (by number) of the copolymer particles having an average diameter of 38 nm. Particle sizes of the copolymer can be determined, for example, via dynamic light scattering experiments.

When the copolymer is in amorphous form, the force of the intramolecular interactions weakens sufficiently such that individual polymers unfold and are in a linear form or in a substantially linear form. While most of the individual copolymer unfold, it is possible that some copolymers remain in condensed or semi-condensed form.

A condensed form is the least soluble form of the copolymer in aqueous solution and an amorphous form is the most soluble form of the polymer in an aqueous solution compared to all three forms. The amorphous form can be present, and/or of higher population, and/or at higher pHs (pH basic conditions) and/or when the concentration of the copolymer of the present invention is low enough in an aqueous solution (for example, at a concentration of from 0.1 wt % to 5 wt %).

The polyvinyl alcohol acrylate dispersion copolymer of the present invention can exhibit reversible dispersibility or reversible solubility; an unexpected phenomenon for a PVOH stabilized latex. The ability of the copolymer to become more dispersed or more soluble and to become less dispersed or less soluble can be achieved by altering the pH of the dispersion. For instance, an aqueous solution having the copolymer of the present invention in condensed form can have a pH of from about 2 to about 5 or from about 2 to about 3, and, at this pH, the copolymer of the present invention can exhibit low solubility in the aqueous solution, i.e., the copolymers in water are in the form of a suspension. Upon raising the pH of the aqueous solution to a pH of from about 5.5 to about 8, by adding an alkali to the aqueous solution, the copolymer of the present invention can transition to the amorphously-dissolved form and exhibit increased solubility in the aqueous medium. Thereafter, the pH of the aqueous solution can be reversibly-lowered, for example, to from about 2 to about 5 or to from about 2 to about 3, and the copolymer of the present invention can return to the condensed form. Upon returning to the condensed form, the copolymer of the present invention can, once again, exhibit low solubility in the aqueous solution. The pH can be lowered by adding an acid to the aqueous solution having the copolymer of the present invention amorphously-dissolved or amorphously-dispersed therein.

The pH of the aqueous solution having the copolymer of the present invention therein, can be increased or decreased, step-wisely, or in a gradient of change, by stepwise adding of an allotment of alkali or an allotment of acid, respectively. The allotment of alkali or acid can be added, e.g., by a dropper that contains the alkali or acid. The alkali or acid can be an aqueous solution of the alkali or acid. The alkali can be any alkali described herein, and the acid can be, e.g., acetic acid, hydrochloric acid, hydrobromic acid, nitric acid, or sulphuric acid. The concentration of the alkali or acid is not particularly limited, so long as the alkali or acid can change the pH of the aqueous solution. The concentration can be, for example, from 0.01 molar to 5 molar, or from 0.05 molar to 3 molar, or from 0.1 to 1 molar, including any sub-value therebetween.

The method can comprise, consist essentially of, consist of, include, or has, a step of adding or mixing together one or more water-soluble monomers and at least one acryl monomer in an aqueous solution comprising, consisting essentially of, consisting of, or including, water and a polyvinyl alcohol polymer, to obtain an aqueous solution of monomers and free polyvinyl alcohol. The step of adding or mixing can take place for at least 15 minutes or more, e.g., from 15 minutes to two hours or more. The step of polymerizing can be initiated by adding an initiator, such as ammonium persulphate, sodium bisulphite, hydrogen peroxide, and t-butyl hydroperoxide, to the aqueous solution of monomers and free polyvinyl alcohol.

As an alternative, the method can comprise, consist essentially of, consist of, include, or has, a step of stepwise or semi-continuous addition of monomers to a reactor at a temperature of from 35° C. to 80° C. The reactor can comprise the polyvinyl alcohol main chain, in unreacted form, prior to the stepwise or semi-continuous addition of monomers to the reactor. The temperature range can be, for example, from 40° C. to 70° C., and is preferably 65° C. The method can also comprise, consist essentially of, consist of, include, or have, a step of polymerizing by adding an initiator, such as ammonium persulphate, hydrogen peroxide, and t-butyl hydroperoxide, to the aqueous solution of monomers and free polyvinyl alcohol mixture. A reducing agent such as sodium bisulphite, ferrous sulphate, ascorbic acid, tartaric acid, or a combination thereof can be used with organic or non-organic peroxides for efficient free radical development at lower temperature.

The initiator can be added all at once and at the beginning of the polymerization, or can be added over time, such as dropwise and over a period of time. If added dropwise, the period of time for dropwise semi-continuous adding of the monomers can be from 15 minutes to five hours or more, from 30 minutes to three hours, or from 45 minutes to two hours.

Upon addition of the initiator, either in whole or in part, the aqueous solution of monomer and free polyvinyl alcohol can be considered a reactive solution, and graft-polymerization of the monomers can take place in the reactive solution. The temperature of the reactive solution during the polymerization can be from 30° C. to 90° C., e.g., from 30° C. to 85° C., or from 40° C. to 80° C., with all numbers and values therein being included in this range.

The method can also comprise, consist essentially of, consist of, include, or has, a step of terminating the polymerization step. Polymerization termination can occur by adding hydroquinone to the reactive solution.

Another aspect of the present invention is a method of making an aqueous solution of the copolymer according to the present invention. The method can comprise, consist essentially of, consist of, include, or is, a step of adding alkali to a dispersion, to increase the pH of the dispersion to be from 4 to 8 (e.g., from above 5 to 8) and form an aqueous solution of the copolymer. In the method, the dispersion copolymer can comprise, consist essentially of, consist of, include, or is, an aqueous phase and the copolymer, which is dispersed in the aqueous phase.

The dispersion can have a pH of from 2 to 5 or from 2 to 3 prior to the step of adding the alkali to the dispersion.

The alkali can be any compound or composition that has a basic pH and is capable of increasing the pH of the dispersion. Examples of the alkali include, but are not limited to, caustic materials, alkali materials (e.g., alkali metal materials, alkaline earth metal materials), and basic buffering materials, or any combinations thereof. The alkali can be inorganic or organic, or combinations or mixtures of these different types of alkali materials. The alkali can be, for example, an alkali metal hydroxide, an alkali metal oxide, an alkali metal phosphate, an alkali metal carbonate, an alkali metal bicarbonate, an alkaline earth hydroxide, an alkaline earth oxide, an alkaline earth phosphate, an alkaline earth carbonate, ammonium zirconium carbonate, organotitanate, organozirconate, ammonium hydroxide, ammonium carbonate, ammonium bicarbonate, alkali metal silicate, urea, substituted urea, a cyanate, an alkylamine, an alkanolamine, a quaternary ammonium salt, a salt of a weak acid and a strong base, an alkaline buffering solution, polyalkali metal pyrophosphates, or any combinations thereof. An example of an alkali metal hydroxide which may be used is NaOH. The alkali salts can be used as brines or in water-soluble salt forms. As an option, an alkaline buffering agent can be used in the adhesive base formulation to establish alkalinity and resist pH changes. Examples of alkaline buffers which can be used include, for example, magnesium oxide, and an aqueous solution of disodium phosphate and monosodium phosphate. Examples of alkanolamines include triethanolamine, diethanolamine, or monoethanolamine. The alkali can be, for example, an Arrhenius base (i.e., a substance that ionizes in water to produce hydroxide ions), a Bronsted-Lowry base (i.e., a substance that can accept a proton or hydrogen cation (H⁺)), or a Lewis base (i.e., a species that donates an electron pair), provided its introduction can affect an increase in the pH of an adhesive base formulation.

The dosage rate of the alkali depends on factors of the level of pH increase sought, the base strength of the particular material, and the addition rate. As a non-limiting example, to increase the pH of the dispersion about 0.5 unit, a 10% by weight NaOH solution can be added in a wt:wt ratio (solids only basis) to the dispersion having an original pH in water of about 4.0 to about 6.0 in a range amount of about 1/30 to about 30/1, such as 1/10 or 10/1, or other range values. The magnitude of further increases in pH obtained by further increasing the amount of alkali added may be approximately proportional or at least may trend together.

As an alternative to adding alkali, the aqueous dispersion can be diluted with water to raise the pH. The transition from the condensed, to semi-condensed, to amorphously-dissolved, form of the copolymer in the aqueous dispersion can take place while the water is being added to the low-pH aqueous dispersion.

The present invention can include any combination of these various features or embodiments above and/or below as set forth in the following sentences and paragraphs. Any combination of disclosed features herein is considered part of the present invention and no limitation is intended with respect to combinable features.

The present invention includes the following aspects/embodiments/features in any order and/or in any combination:
1. The present invention relates, in part, to a reactive aqueous solution for emulsion polymerization, the reactive aqueous solution comprising: an acryl monomer being an ester of an unsaturated carboxylic acid monomer, an ester of acrylic acid, an ester of methacrylic acid, an acrylate monomer, a methacrylate monomer, or a combination thereof; a partially hydrolyzed polyvinyl alcohol having acetate groups and hydroxyl groups and having a degree of hydrolysis of at least 50 mol %; one or more water-soluble monomers selected from a carboxylic acid monomer and an amide monomer; and water, wherein the one or more water-soluble monomers are present in the reactive aqueous solution in an amount of from 0.5% by volume to 4.0% by volume, based on the total volume of the reactive aqueous solution, the amount of acryl monomer, by weight, based on the total weight of the reactive aqueous solution, is equal to or greater than the amount by weight of the partially hydrolyzed polyvinyl alcohol, and the acryl monomer and the partially hydrolyzed polyvinyl alcohol are present in the reactive aqueous solution in amounts that provide, upon copolymerization, a stable dispersion of a covalently bonded polyvinyl alcohol acrylate copolymer that has at least three different types of repeating units.
2. The reactive aqueous solution of any preceding or following embodiment/feature/aspect, wherein the reactive aqueous solution is free of any other copolymerizable surfactants besides the partially hydrolyzed polyvinyl alcohol.
3. The reactive aqueous solution of any preceding or following embodiment/feature/aspect, wherein the acryl monomer is present in the reactive aqueous solution in an amount of from 2 to 40 parts by weight based on 100 parts by weight of the water, the partially hydrolyzed polyvinyl alcohol is present in the reactive aqueous solution in an amount of from 2 to 25 parts by weight based on 100 parts by weight of the water, and the one or more water-soluble monomers are present in the reactive aqueous solution in an amount of from 1 to 6 parts by weight based on 100 parts by weight of the water.
4. The reactive aqueous solution of any preceding or following embodiment/feature/aspect, wherein the one or more water-soluble monomers are present in the reactive aqueous solution in an amount of from 1% by volume to 2% by volume, based on the total volume of the reactive aqueous solution.
5. The reactive aqueous solution any preceding or following embodiment/feature/aspect, wherein the acryl monomer comprises an acrylate monomer, and the acrylate monomer is selected from 2-hydroxyethyl methacrylate, hydroxypropyl methacrylate, hydroxypropyl acrylate, 2-ethylhexyl acrylate, 2-hydroxyethyl acrylate, 4-hydroxybutyl acrylate, ethyl acrylate, methyl acrylate, methyl methacrylate, butyl acrylate, 2-hydroxyethyl acrylate, stearyl acrylate, stearyl methacrylate, isobutyl methacrylate, dimethyl amino ethyl acrylate, dimethyl amino ethyl methacrylate, acrylonitrile, 2-octyl acrylate, iso-butyl acrylate, tert-butyl acrylate, 2-dimethylamino ethyl methacrylate, 3-dimethylamino propyl methacrylate, N-isopropyl meth acrylamide, 2-trimethylammonium ethyl methacrylate chloride, 3-trimethylammonium propyl meth acrylamide chloride, and ureido methacrylate.
6. The reactive aqueous solution of any preceding or following embodiment/feature/aspect, wherein the acrylate monomer is selected from hydroxyethyl methacrylate, hydroxypropyl methacrylate, 2-ethylhexyl acrylate, ethyl acrylate, ureidomethacrylate, and 4-hydroxybutyl acrylate.
7. The reactive aqueous solution of any preceding or following embodiment/feature/aspect, wherein the degree of hydrolysis of the partially hydrolyzed polyvinyl alcohol is from 72 mol % to 96 mol %.
8. The reactive aqueous solution of any preceding or following embodiment/feature/aspect, wherein the amount of acryl monomer is at least 5 parts by weight greater than the amount of partially hydrolyzed polyvinyl alcohol.
9. The reactive aqueous solution of any preceding or following embodiment/feature/aspect, further comprising a water-miscible acrylate monomer that differs from the acryl monomer and is insoluble in water at 25° C. and one atmosphere pressure.
10. The present invention further relates to a stable dispersion comprising a reaction product of the reactive aqueous solution of any preceding or following embodiment/feature/aspect, wherein the stable dispersion comprises a covalently bonded polyvinyl alcohol acrylate copolymer that has at least three different types of repeating units, and the copolymer is present in the stable dispersion as particles having a median particle size distribution of from 0.05 micron to 10 microns.
11. The stable dispersion of any preceding or following embodiment/feature/aspect, wherein the particles have a median particle size distribution of from 0.1 micron to 5 microns.
12. The stable dispersion of any preceding or following embodiment/feature/aspect, wherein the stable dispersion is stable for at least one freeze-thaw stability cycle and exhibits a shelf-life stability of at least 6 months at a temperature of 25° C. and a pressure of 1 atmosphere.
13. The present invention further relates to a diluted stable dispersion comprising the stable dispersion of any preceding or following embodiment/feature/aspect, diluted with water, wherein the diluted stable dispersion has a weight ratio of water to copolymer of from 10:1 to 100:1.
14. The present invention further relates to a paper or paperboard product comprising paper or paperboard at least partially coated with the diluted stable dispersion of any preceding or following embodiment/feature/aspect.
15. The present invention further relates to a stable dispersion comprising a reaction product of the reactive aqueous solution of any preceding or following embodiment/feature/aspect, wherein the stable dispersion comprises a covalently bonded polyvinyl alcohol acrylate copolymer that has at least four different types of repeating units, and the copolymer is present in the stable dispersion as particles having a median particle size distribution of from 0.05 micron to 10 microns.
16. The stable dispersion of any preceding or following embodiment/feature/aspect, wherein the particles have a median particle size distribution of from 0.1 micron to 5 microns.
17. The stable dispersion of any preceding or following embodiment/feature/aspect, wherein the water-miscible acrylate monomer that differs from the acryl monomer and is insoluble in water at 25° C. and one atmosphere pressure, is selected from 2-hydroxyethyl methacrylate, 2-hydroxyethyl ethacrylate, 2-methylhexyl acrylate, 2-ethylhexyl acrylate, and butyl acrylate.
18. The present invention further relates to a method of forming a stable dispersion, comprising reacting, through emulsion polymerization, the reactive aqueous solution of any preceding or following embodiment/feature/aspect to copolymerize (1) the acryl monomer, (2) the partially hydrolyzed polyvinyl alcohol, and (3) the one or more water-soluble monomers, together, to form a stable dispersion of a covalently bonded polyvinyl alcohol acrylate copolymer that has at least three different types of repeating units.
19. The method of any preceding or following embodiment/feature/aspect, comprising: mixing the water with the partially hydrolyzed polyvinyl alcohol, to form a mixture; heating the mixture; adding the one or more water-soluble monomers to the mixture to form a second mixture; and adding the acryl monomer to the second mixture.
20. The method of any preceding or following embodiment/feature/aspect, comprising: mixing the water with the partially hydrolyzed polyvinyl alcohol, to form a mixture; heating the mixture; batch or semi-continuously feeding the one or more water-soluble monomers to the mixture to form a second mixture; and batch or semi-continuously feeding the acryl monomer to the second mixture.
21. The method of any preceding or following embodiment/feature/aspect, wherein the one or more water-soluble monomers comprises a carboxylic acid monomer, the copolymer comprises carboxylic acid groups, and the method further comprises adding a metal-containing alkali agent in an amount sufficient to convert the copolymer to a completely water-soluble form and change the latex dispersion into a solution.
22. The method of any preceding or following embodiment/feature/aspect, further comprising diluting the stable dispersion with water to form a diluted product having a weight ratio of water to copolymer of from 10:1 to 100:1.
23. The method of any preceding or following embodiment/feature/aspect, further comprising coating at least a portion of a paper or paperboard with the diluted product, to form a coated product.
24. The method of any preceding or following embodiment/feature/aspect, further comprising drying the coated product to form a dried product.
25. The present invention further relates to a paper or paperboard product comprising the dried product made according to the method of any preceding or following embodiment/feature/aspect.
26. The present invention further relates to a latex dispersion of a copolymer in water, the copolymer comprising three or more different types of repeating monomeric units and being the emulsion polymerization product of (1) an acryl monomer that is an ester of an unsaturated carboxylic acid monomer, an ester of acrylic acid, an ester of methacrylic acid, an acrylate monomer, a methacrylate monomer, or a combination thereof, (2) a partially hydrolyzed polyvinyl alcohol having a degree of hydrolysis of from 72 mol % to 96 mol %, and (3) one or more water-soluble monomers selected from a carboxylic acid monomer and an amide monomer, wherein
the one or more water-soluble monomers are present in the latex dispersion, as reacted monomeric units, in an amount of from 0.5% by volume to 4.0% by volume, based on the total volume of the latex dispersion,
the amount of reacted monomeric units of the acryl monomer, in the latex dispersion, is, by weight, equal to or greater than the amount of reacted monomeric units of the partially hydrolyzed polyvinyl alcohol in the latex dispersion, and
the latex dispersion is free of any other copolymerizable surfactants besides the partially hydrolyzed polyvinyl alcohol.
27. The latex dispersion of any preceding or following embodiment/feature/aspect, wherein the one or more water-soluble monomers comprises a carboxylic acid monomer, the copolymer comprises carboxylic acid groups, and the copolymer exhibits a convertibility that enables the copolymer to become completely water-soluble through the addition to the latex dispersion of a metal-containing alkali agent that converts the carboxylic acid groups into corresponding alkali metal salts.

The present invention can include any combination of these various features or embodiments above and/or below as set forth in sentences and/or paragraphs. Any combination of disclosed features herein is considered part of the present invention and no limitation is intended with respect to combinable features.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

It will be apparent to those skilled in the art that various modifications and variations can be made to the embodiments of the present invention without departing from the spirit or scope of the present invention. Thus, it is intended that the present invention covers other modifications and variations of this invention provided they come within the scope of the appended claims and their equivalents.

What is claimed is:

1. A reactive aqueous solution for emulsion polymerization, the reactive aqueous solution comprising: an acryl monomer; a partially hydrolyzed polyvinyl alcohol having acetate groups and hydroxyl groups and having a degree of hydrolysis of at least 50 mol %; one or more water-soluble monomers selected from a carboxylic acid monomer and an amide monomer; and water, wherein
the acryl monomer comprises an ester of an unsaturated carboxylic acid monomer, an ester of acrylic acid, an ester of methacrylic acid, an acrylate monomer, a methacrylate monomer, or a combination thereof,
the one or more water-soluble monomers are present in the reactive aqueous solution in an amount of from 0.5% by volume to 4.0% by volume, based on the total volume of the reactive aqueous solution,
the amount of acryl monomer, by weight, based on the total weight of the reactive aqueous solution, is equal to or greater than the amount by weight of the partially hydrolyzed polyvinyl alcohol, and
the acryl monomer and the partially hydrolyzed polyvinyl alcohol are present in the reactive aqueous solution in amounts that provide, upon copolymerization, a stable dispersion of a covalently bonded polyvinyl alcohol acrylate copolymer that has at least three different types of repeating units.

2. The reactive aqueous solution of claim 1, wherein the reactive aqueous solution is free of any other copolymerizable surfactants besides the partially hydrolyzed polyvinyl alcohol.

3. The reactive aqueous solution of claim 1, wherein the acryl monomer is present in the reactive aqueous solution in an amount of from 2 to 40 parts by weight based on 100 parts by weight of the water, the partially hydrolyzed polyvinyl alcohol is present in the reactive aqueous solution in an amount of from 2 to 25 parts by weight based on 100 parts by weight of the water, and the one or more water-soluble monomers are present in the reactive aqueous solution in an amount of from 1 to 6 parts by weight based on 100 parts by weight of the water.

4. The reactive aqueous solution of claim 1, wherein the one or more water-soluble monomers are present in the reactive aqueous solution in an amount of from 1% by volume to 2% by volume, based on the total volume of the reactive aqueous solution.

5. The reactive aqueous solution of claim 1, wherein the acryl monomer comprises an acrylate monomer, and the acrylate monomer is selected from 2-hydroxyethyl methacrylate, hydroxypropyl methacrylate, hydroxypropyl acrylate, 2-ethylhexyl acrylate, 2-hydroxyethyl acrylate, 4-hydroxybutyl acrylate, ethyl acrylate, methyl acrylate, methyl methacrylate, butyl acrylate, 2-hydroxyethyl acrylate, stearyl acrylate, stearyl methacrylate, isobutyl methacrylate, dimethyl amino ethyl acrylate, dimethyl amino ethyl methacrylate, acrylonitrile, 2-octyl acrylate, iso-butyl acrylate, tert-butyl acrylate, 2-dimethylamino ethyl methacrylate, 3-dimethylamino propyl methacrylate, N-isopropyl meth acrylamide, 2-trimethylammonium ethyl methacrylate chloride, 3-trimethylammonium propyl meth acrylamide chloride, and ureido methacrylate.

6. The reactive aqueous solution of claim 5, wherein the acrylate monomer is selected from hydroxyethyl methacrylate, hydroxypropyl methacrylate, 2-ethylhexyl acrylate, ethyl acrylate, ureidomethacrylate, and 4-hydroxybutyl acrylate.

7. The reactive aqueous solution of claim 1, wherein the degree of hydrolysis of the partially hydrolyzed polyvinyl alcohol is from 72 mol % to 96 mol %.

8. The reactive aqueous solution of claim 1, wherein the amount of acryl monomer is at least 5 parts by weight greater than the amount of partially hydrolyzed polyvinyl alcohol.

9. The reactive aqueous solution of claim 1, further comprising a water-miscible acrylate monomer that differs from the acryl monomer and is insoluble in water at 25° C. and one atmosphere pressure.

10. A stable dispersion comprising a reaction product of the reactive aqueous solution of claim 1, wherein the stable dispersion comprises a covalently bonded polyvinyl alcohol acrylate copolymer that has at least three different types of repeating units, and the copolymer is present in the stable dispersion as particles having a median particle size distribution of from 0.05 micron to 10 microns.

11. The stable dispersion of claim 10, wherein the particles have a median particle size distribution of from 0.1 micron to 5 microns.

12. The stable dispersion of claim 10, wherein the stable dispersion is stable for at least one freeze-thaw stability cycle and exhibits a shelf-life stability of at least 6 months at a temperature of 25° C. and a pressure of 1 atmosphere.

13. A diluted stable dispersion comprising the stable dispersion of claim 10 diluted with water, wherein the diluted stable dispersion has a weight ratio of water to copolymer of from 10:1 to 100:1.

14. A paper or paperboard product comprising paper or paperboard at least partially coated with the diluted stable dispersion of claim 13.

15. A stable dispersion comprising a reaction product of the reactive aqueous solution of claim 9, wherein the stable dispersion comprises a covalently bonded polyvinyl alcohol acrylate copolymer that has at least four different types of repeating units, and the copolymer is present in the stable dispersion as particles having a median particle size distribution of from 0.05 micron to 10 microns.

16. The stable dispersion of claim 15, wherein the particles have a median particle size distribution of from 0.1 micron to 5 microns.

17. The stable dispersion of claim 15, wherein the water-miscible acrylate monomer that differs from the acryl monomer and is insoluble in water at 25° C. and one atmosphere pressure, is selected from 2-hydroxyethyl methacrylate, 2-hydroxyethyl ethacrylate, 2-methylhexyl acrylate, 2-ethylhexyl acrylate, and butyl acrylate.

18. A method of forming a stable dispersion, comprising reacting, through emulsion polymerization, the reactive aqueous solution of claim 1 to copolymerize (1) the acryl monomer, (2) the partially hydrolyzed polyvinyl alcohol, and (3) the one or more water-soluble monomers, together, to form a stable dispersion of a covalently bonded polyvinyl alcohol acrylate copolymer that has at least three different types of repeating units.

19. The method of claim 18, comprising:
mixing the water with the partially hydrolyzed polyvinyl alcohol, to form a mixture;
heating the mixture;
adding the one or more water-soluble monomers to the mixture to form a second mixture; and
adding the acryl monomer to the second mixture.

20. The method of claim 18, comprising:
mixing the water with the partially hydrolyzed polyvinyl alcohol, to form a mixture;
heating the mixture;
batch or semi-continuously feeding the one or more water-soluble monomers to the mixture to form a second mixture; and
batch or semi-continuously feeding the acryl monomer to the second mixture.

21. The method of claim 18, wherein the one or more water-soluble monomers comprises a carboxylic acid monomer, the copolymer comprises carboxylic acid groups, and the method further comprises adding a metal-containing alkali agent in an amount sufficient to convert the copolymer to a completely water-soluble form and change the latex dispersion into a solution.

22. The method of claim 18, further comprising diluting the stable dispersion with water to form a diluted product having a weight ratio of water to copolymer of from 10:1 to 100:1.

23. The method of claim 22, further comprising coating at least a portion of a paper or paperboard with the diluted product, to form a coated product.

24. The method of claim 23, further comprising drying the coated product to form a dried product.

25. A paper or paperboard product comprising the dried product made according to the method of claim 24.

26. A latex dispersion of a copolymer in water, the copolymer comprising three or more different types of repeating monomeric units and being the emulsion polymerization product of (1) an acryl monomer that is an ester of an unsaturated organic acid monomer, (2) a partially hydrolyzed polyvinyl alcohol having a degree of hydrolysis of from 72 mol % to 96 mol %, and (3) one or more water-soluble monomers selected from a carboxylic acid monomer and an amide monomer, wherein
the one or more water-soluble monomers are present in the latex dispersion, as reacted monomeric units, in an amount of from 0.5% by volume to 4.0% by volume, based on the total volume of the latex dispersion,
the amount of reacted monomeric units of the acryl monomer, in the latex dispersion, is, by weight, equal to or greater than the amount of reacted monomeric units of the partially hydrolyzed polyvinyl alcohol in the latex dispersion,
and the latex dispersion is free of any other copolymerizable surfactants besides the partially hydrolyzed polyvinyl alcohol.

27. The latex dispersion of claim 26, wherein the one or more water-soluble monomers comprises a carboxylic acid monomer, the copolymer comprises carboxylic acid groups, and the copolymer exhibits a convertibility that enables the copolymer to become completely water-soluble through the addition to the latex dispersion of a metal-containing alkali agent that converts the carboxylic acid groups into corresponding alkali metal salts.
